(19) United States
(12) Patent Application Publication
(10) Pub. No.: US 2018/0220099 A1
(43) Pub. Date: Aug. 2, 2018

(54) DEVICE, SYSTEM AND METHOD FOR OPERATING ELECTRIC APPLIANCE BY MOBILE TERMINAL

(71) Applicant: BOE TECHNOLOGY GROUP CO., LTD., Beijing (CN)

(72) Inventor: Weiguo LI, Beijing (CN)

(73) Assignee: BOE TECHNOLOGY GROUP CO., LTD.

(21) Appl. No.: 15/541,376

(22) PCT Filed: Jan. 5, 2017
(86) PCT No.: PCT/CN2017/070261

§ 371 Date: Jul. 2, 2017

(30) Foreign Application Priority Data
May 13, 2016 (CN) 201610314539.3

(51) Int. Cl. H04N 5/44; H04N 21/472; H04M 1/725

(52) U.S. Cl. CPC H04N 5/4403; H04N 21/472; H04M 1/72533; G06F 3/0482; H04N 2005/4444; H04N 2005/4437; H04N 2005/4425

(57) ABSTRACT

A system for operating an electric appliance by a mobile terminal is disclosed. The mobile terminal includes a platform-independent GUI presentation unit; a sending unit configured to send, to the electric appliance, an operation instruction and/or query request based on the user interaction input received via a GUI element; and a result receiving unit configured to receive the instruction execution result and/or query result. The electric appliance includes platform-dependent components, including: a receiving unit configured to receive the operation instruction and/or query request; a control unit configured to execute the instruction and/or query; a display unit configured to display contents; and a result report unit configured to report the instruction execution result and/or query result to the mobile terminal. The GUI presentation unit changes at least one GUI element presented, so as to reflect the instruction execution result and/or query result in the GUI.

### RELATED APPLICATIONS

The present application is the U.S. national phase entry of PCT/CN2017/070261 with an International filing date of Jan. 5, 2017, which claims the benefit of Chinese Patent Application No. 201610314539.3, filed on May 13, 2016, the entire disclosure of which is incorporated herein by reference.

### TECHNICAL FIELD

The present disclosure relates to the technical field of operating an electric appliance by a mobile terminal.

### BACKGROUND ART

With the rapid development and popularization of such intelligent mobile terminals as smart phones and tablet devices, there occurs, in the prior art, the technology of using an intelligent mobile terminal to simulate an infrared controller of electric appliances, such as smart TVs/display devices. The said technology is achieved by installing a controller APP in an intelligent mobile terminal to simulate the outlook and functions of a conventional infrared controller, and a user operates the interface of the APP, which is similar to an infrared controller, to realize one-way operation of smart TVs/display devices through an infrared, Wi-Fi or Bluetooth technology. The controller APP, however, is very simple and monotonous in terms of both interface settings and functions, which cannot meet the increasing demands of users.

### SUMMARY

System software of current smart TVs/display devices is integrally developed and then secured to a FLASH storage area of the entire machine. Although a majority of system software can be upgraded off line or on line, the upgrading requires certain technical background or background support. In addition, a smart TV/display device with a super-large screen has a large platform, the initial development of a system software can be limited due to the number and location of the platform, which is disadvantageous to fast development. Furthermore, the software development source or version in a smart TV/display device is always left behind by a mobile terminal for a while, R&D human resources engaged in intelligent mobile terminal APP are far leading in terms of technological maturity and number, and there is no need to keep an close eye on the specific platform of a target smart TV/display device while developing an APP on a mobile terminal, such that development and debugging of the APP would be highly easy and flexible with guaranteed maturity and greatly shortened development circle.

Thus, it is desired in the art to provide an improved system and method for operating an electric appliance by a mobile terminal, so as to overcome the defects in the prior art.

The system software on the conventional electric appliance can be effectively divided according to different characteristics of software development for electric appliances and intelligent mobile terminals. The overall system software shall be divided purposefully and implemented respectively on an electric appliance and an intelligent mobile terminal to form a cooperative and complementary complete system. After effective division of the entire system software of an electric appliance, a TV terminal would no longer be in a dominant position, which fundamentally simplifies the system design and use by fully utilizing the source from an intelligent mobile terminal, rendering the design process and use much simpler. This mode maximally improves software development efficiency and quality, greatly enhances the simplicity of a smart TV user interface, increases software running speed and improves software reusability, simplifies software maintenance and shortens development circle, thereby radically optimizing the function, process and efficiency of the overall unit software development. The data exchange between a mobile terminal and an electric appliance can be greatly reduced and the matching and loading of graphics user interfaces (GUI) can be accelerated.

According to one aspect of the present disclosure, there is provided a system for operating an electric appliance by a mobile terminal, which comprises the electric appliance and the mobile terminal. Wherein the mobile terminal comprises a platform-independent GUI presentation unit configured to present a GUI comprising at least one GUI element, the at least one GUI element being configured to display the status of the electric appliance and/or receive a user interaction input for the user to operate the electric appliance; a sending unit configured to send, to the electric appliance, an operation instruction and/or query request based on the user interaction input; and a result receiving unit configured to receive an instruction execution result and/or query result from the electric appliance. The electric appliance comprises platform-dependent components, which include: a receiving unit configured to receive the operation instruction and/or query request from the mobile terminal; a control unit configured to execute the instruction and/or query in response to the operation instruction and/or query request received from the mobile terminal; a display unit configured to display contents and adjust the content display according to the instruction execution result; and a result report unit configured to report the instruction execution result and/or query result to the mobile terminal. Wherein the GUI presentation unit changes at least one GUI element presented according to the instruction execution result and/or query result received from the electric appliance, so as to reflect the instruction execution result and/or query result in the presented GUI.

In an embodiment, the electric appliance comprises a smart TV.

In an embodiment, the smart TV comprises a GUI presentation unit, the at least one GUI element in the mobile terminal comprises an option available for user selection. When the user selects the option, the GUI presentation unit of the smart TV displays a GUI independent from the at least one GUI element.

In an embodiment, the mobile terminal comprises a GUI pushing unit configured to push a user-customized GUI to the smart TV, the smart TV comprising a GUI presentation unit configured to present the user-customized GUI.

In an embodiment, the mobile terminal comprises an event pushing unit configured to push an event occurring in the mobile terminal to the smart TV, the smart TV comprising an event notification unit configured to notify the event occurring in the mobile terminal to the user.

In an embodiment, the electric appliance comprises a plurality of electric appliances and the plurality of electric appliances are controlled by the mobile terminal in a centralized manner.

In an embodiment, the mobile terminal comprises a plurality of mobile terminals respectively associated with a plurality of users, each mobile terminal having a GUI used for a corresponding user.

In an embodiment, the mobile terminal comprises a user identification unit configured to identify a user logged in to the mobile terminal; a memory configured to store a plurality of user profiles associated with a plurality of users, each user file defining the GUI used for a corresponding user. Wherein the GUI presentation unit is configured to present a corresponding GUI according to the user profile corresponding to the identified user.

In an embodiment, the mobile terminal comprises a general-purpose intelligent mobile terminal.

In an embodiment, the mobile terminal comprises a software update unit configured to receive a system software update package from a network server and update the platform-independent GUI presentation unit in the mobile terminal.

In an embodiment, the mobile terminal also comprises a software package pushing unit configured to push the part of the received update package that is related to the electric appliance to the electric appliance. The electric appliance further comprises a software update unit configured to update system software in the electric appliance according to the part of the received update package.

In an embodiment, the electric appliance comprises a memory configured to store an environment variable.

In an embodiment, the memory is configured to back up the environment variable before updating the system software in the mobile terminal and the electric appliance.

In an embodiment, the mobile terminal further comprises an uploading unit configured to transmit to a network server the system software update package for the electric appliance developed in the mobile terminal or another computing device.

In an embodiment, the system software update package is used to configure the platform-independent GUI and/or the platform-dependent components.

In an embodiment, the network server comprises a cloud server.

In an embodiment, the mobile terminal and the electric appliance are configured to perform two-way communication by means of infrared, Bluetooth or WLAN.

According to another aspect of the disclosure, there is provided a mobile terminal for use in any system as stated above.

According to another aspect of the disclosure, there is provided an electric appliance for use in any system as stated above.

According to another aspect of the disclosure, there is provided a method for operating an electric appliance by a mobile terminal, comprising the steps of: displaying contents in the electric appliance; presenting, in the mobile terminal, the status of the electric appliance and receiving a user interaction input for the user to operate the content display in the electric appliance by a platform-independent GUI configured therein; sending an operation instruction and/or query request based on the user interaction input from the mobile terminal to the electric appliance; executing the instruction and/or query request in the electric appliance in response to the operation instruction and/or query request and adjusting the content display according to an instruction execution result; reporting the instruction execution result and/or query result from the electric appliance to the mobile terminal; and changing the GUI in the mobile terminal according to the instruction execution result and/or query result received from the electric appliance, so as to reflect the instruction execution result and/or query result in the GUI.

In an embodiment, the electric appliance comprises a smart TV.

In an embodiment, the method further comprises the steps of pushing a user-customized GUI from the mobile terminal to the smart TV, and presenting the pushed user-customized GUI in the smart TV.

In an embodiment, the method further comprises the steps of receiving a system software update package in the mobile terminal from a network server; and performing an update so as to update the platform-independent GUI presentation unit in the mobile terminal by the system software update package.

In an embodiment, the method further comprises the steps of pushing the part of the received update package that is related to the electric appliance from the mobile terminal to the electric appliance; and performing the update in the electric appliance according to the pushed part in response to the received pushed part so as to update system software in the electric appliance.

In an embodiment, the method further comprises the step of backing up the environment variable in the electric appliance before updating the system software.

In an embodiment, the method further comprises the step of transmitting a system software update package for the electric appliance developed in the mobile terminal or another computing device from the mobile terminal to a network server.

In an embodiment, the system software update package is used to configure the platform-independent GUI and/or the platform-dependent components.

According to another aspect of the present disclosure, there is provided a computer readable storage medium that stores a computer readable instruction enabling a computing device to perform any method as stated above when being executed by the computing device.

In some embodiments, according to different characteristics of system development of smart TVs/display devices and intelligent mobile terminals, the system software in the current conventional smart TVs/display devices can be effectively divided and respectively implemented on the smart TVs/display devices and intelligent mobile terminals so as to form a cooperative and complementary integral system. Thus, the development cycle of smart TVs/display devices can be greatly sped up, the complexity of software in TVs/display devices can be greatly decreased, the reusability of software development results can be highly enhanced, in such a manner to simplify subsequent maintenance of system software and meanwhile organically incorporate information in intelligent mobile terminals into smart TVs/display devices according to personal needs.

### BRIEF DESCRIPTION OF DRAWINGS

To explain the technical solutions in the embodiments more described herein clearly, the embodiments will be described with reference to the drawings. The following drawings are only related to some embodiments of the present disclosure. Those skilled in the art can obtain other drawings according to these drawings without making any inventive effort.

FIG. 1 is a system composition schematic view of a system according to an embodiment of the present disclosure;

FIG. 2 is a structural block diagram of a mobile terminal according to an embodiment of the present invention;

FIG. 3 is a structural block diagram of an electric appliance according to an embodiment of the present invention;

FIG. 4 is a system operation flowchart schematic view according to an embodiment of the present disclosure;

FIG. 5 is a system initial installation flowchart schematic view according to an embodiment of the present disclosure;

FIG. 6 is a system software update flowchart schematic view according to an embodiment of the present disclosure;

FIG. 7 is a system software R&D phase flowchart schematic view according to an embodiment of the present disclosure;

FIG. 8 is a flowchart of a method for operating an electric appliance according to an embodiment of the present disclosure; and

FIG. 9 illustrates an exemplary computing device used for realizing one or more embodiments.

### DETAILED DESCRIPTION

To clarify the object, technical solutions and advantages of some embodiments described herein, the technical solutions of these embodiments will be described explicitly and completely with reference to the drawings. It needs to be pointed out that detailed description of the embodiments is only used to explain the disclosure, rather than limit the protection scope thereof. The embodiments described herein are only a part, not the entirety, of the embodiments of the present disclosure. Based on the embodiments described herein, those skilled in the art can acquire other different embodiments. All the embodiments fall within the protection scope of the present disclosure.

The system software of an electric appliance comprises platform-dependent parts and platform-independent parts. For instance, in smart TVs/display devices, the platform-independent parts in the system software in smart TVs/display devices comprise complex user interaction interfaces UI. These complex user interaction interfaces UI can be transferred to an intelligent mobile terminal, and smart TVs/display devices can focus on realization of platform-dependent driving and background logic, as well as a few notification user interfaces UI. The mobile terminal can quickly implement a user interaction interface with high maturity, reliability and aesthetic appearance, and meanwhile the software maintenance and update of the entire system is transferred to the mobile terminal for control, which can improve the flexibility of software maintenance.

Some embodiments of the present disclosure will be described in detail with reference to the drawings. It needs to be pointed out that for easy explanation, all the following description is depicted by taking a smart TV/display device as an example. Those skilled in the art can understand that the embodiments can also be implemented on other electric appliances.

FIG. 1 is a system composition schematic view of a system 100 according to an embodiment of the present disclosure. As shown, the system 100 can comprise a smart TV/display device 100 and one or more mobile terminals 150. In an embodiment, the system 100 can further comprise a wireless router 130. In the shown embodiment, the one or more mobile terminal 150 comprises a tablet computer 150(1), a smart phone A 150(2) and a smart phone B 150(3). For the sake of clarity and conciseness, only three mobile terminals 150 are shown in the drawings, but the system 100 can comprise more or fewer mobile terminals 150. Additionally, although FIG. 1 only illustrates such two mobile terminals as a tablet computer and a smart phone for the sake of clarity and conciseness, those skilled in the art can understand that various embodiments of the present disclosure can be respectively adapted for other different mobile terminals, especially different intelligent mobile terminals. The intelligent mobile terminals can be general-purpose intelligent mobile terminals so as to enhance practicability of the embodiments of the present disclosure or specialized intelligent mobile terminals with optimized performance and efficiency.

The one or more mobile terminals 150 can directly perform two-way communication with the smart TV/display device 110 by means of infrared, Wi-Fi or Bluetooth technology, or via a wireless router 130, so as to exchange data between the one or more mobile terminals 150 and the smart TV/display device 110.

In some embodiments, the smart TV/display device 100 can comprise platform-dependent parts, including an operating system support, hardware drive, an underlying support library, background data processing logic as well as storage of environment variables and power management, and human-computer interaction support (infrared remote interface, Bluetooth interface, Wi-Fi interface, LAN interface, etc.). In some embodiments, the smart TV/display device 110 can further comprise a most lightweight UI underlying library and/or a notification user interface. For instance, a notification OSD can remain in the smart TV/display device 100. For example, the notification OSD can comprise channel information (station caption, channel number, current program name, starting and ending time, . . . ), volume, channel name, image mode and sound mode, etc.

The platform-independent part in the system software of the smart TV/display device 110 comprises complex user interaction interfaces UI. These complex user interaction interfaces UI can be transferred to the mobile terminal 150, including the most majority of human-computer interaction interfaces of the system software of the smart TV/display device 110. As an example, a user-manipulated (relatively complex) GUI is transferred to a hand-held intelligent mobile terminal, such as levels of menu, list menu, slider and switch in the system. In addition, the system software management and maintenance module can be transferred to the mobile terminal 150. In some embodiments, the mobile terminal 150 can comprise a personal information pushing component (such as call prompt, text message, instant messaging prompt), and can comprise a TV-side running state data backup and a multi-user management function which is responsible for selecting different themes and/or different styles of interaction interface according to different users' preferences.

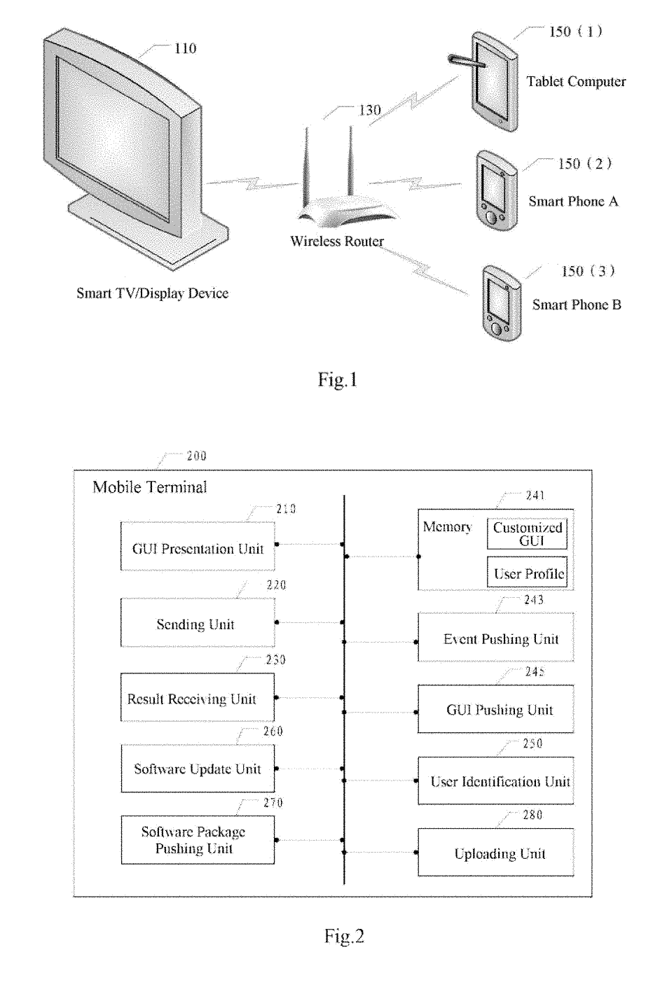

FIG. 2 is a structural block diagram of a mobile terminal 200 according to an embodiment of the present disclosure. As shown in FIG. 2, the mobile terminal 200 can comprise a GUI presentation unit 210, a sending unit 220 and a result receiving unit 230. In some embodiments, the mobile terminal 200 can further comprise a memory 241, an event pushing unit 243, a GUI pushing unit 245, a user identification unit 250, a software update unit 260, a software package pushing unit 270 and/or an uploading unit 280.

The GUI presentation unit 210 of the mobile terminal 200 is a platform-independent GUI presentation unit. The GUI presentation unit 210 can be configured to present a GUI comprising at least one GUI element which is configured to display the state of an electric appliance and/or receive a user interaction input for a user to operate the electric appliance. The user can interact with the GUI to input an instruction that needs to run or a query request, so as to operate and control the electric appliance. In an embodiment, the mobile terminal 200 is used to control an electric appliance having a display unit, such as the smart TV/display device 110 shown in FIG. 1. In an embodiment, the at least one GUI element comprises an option available for user selection. When the user selects the option, the smart TV or display device can be switched to an independent operation mode, showing its own operative GUI independent from the at least one GUI element without being operated by the mobile terminal 200. This manner provides users with more options and achieves forward compatibility.

The sending unit 220 can be configured to send, to the electric appliance, an operation instruction and/or query request based on the user interaction input.

The result receiving unit 230 can be configured to receive the instruction execution result and/or query result from the electric appliance. The GUI presentation unit changes at least one GUI element presented thereby according to the instruction execution result and/or the query result received from the electric appliance, so as to reflect the instruction execution result and/or the query result in a GUI presented thereby. In doing so, the GUI in the mobile terminal 200 can be synchronized with the state of the electric appliance, and the user can send a new operation instruction and a query request in view of the new state of the electric appliance.

The memory 241 can be configured to store various data and programs required for operation of the mobile terminal 200, including, for example, user profile and user-customized GUI data. The memory 241 can also be configured to store various environment variables. The environment variables can comprise various environment data including user usage data. Storage of the data can enable the system to automatically return to the previous use environment when the user uses the system again.

The event pushing unit 243 can be configured to push an event occurring in the mobile terminal to the smart TV/display device. In an embodiment, the smart TV/display device implements a simple notification user interface. For instance, the mobile terminal can send personalized information push to smart TVs/display devices according to users' settings and demands, such as incall reminder, text message reminder and calendar reminder. Thus, when watching a smart TV/display device, a user can know the event occurring in the mobile terminal, such as incall reminder, text message reminder and calendar reminder, without checking the mobile terminal.

The GUI pushing unit 245 can be configured to push a user-customized GUI to the smart TV/display device, wherein the pushed user-customized GUI can be retrieved from the memory 241. In this embodiment, the smart TV/display device can have a GUI presentation unit so as to present the user-customized GUI. In doing so, the mobile terminal can push the user-customized GUI to the smart TV/display device so as to meet the increasingly personalized needs of users and provide a better user experience.

In an embodiment, the mobile terminal 200 can be configured to receive the operational control over a plurality of electric appliances by the user through its GUI. This mode allows the control of smart home in a centralized manner, wherein the mobile terminal serving as a centralized control board controls the plurality of electric appliances. The centralized control mode of smart home provides a more convenient and comfortable experience for users. In another mode, a plurality of mobile terminals 200 can be used to control the electric appliance, wherein each of the plurality of mobile terminals is respectively associated with one user, and the GUI presentation unit 210 of each mobile terminal 200 presents a GUI for a corresponding user, including a GUI customized for the corresponding user. In doing so, the system can provide multi-user support and enhance the flexibility of the system.

The user identification unit 250 can be configured to identify a user logged on to the mobile terminal. In an embodiment, the memory 241 can store a plurality of user profiles associated with a plurality of users respectively with each user profile defining the GUI for a corresponding user, including a GUI customized for a corresponding user. After a user is logged on to a user terminal, the user identification unit 250 can identify the user logged on to the mobile terminal. For instance, the user can be identified through the login name, user ID, password, fingerprint, iris and facial features thereof. Then, the GUI presentation unit 210 can search the memory 241 for the user profile corresponding to the identified user, and present the GUI defined by the user profile according to the searched user profile. This manner can provide multi-user support and enhance the flexibility of the system.

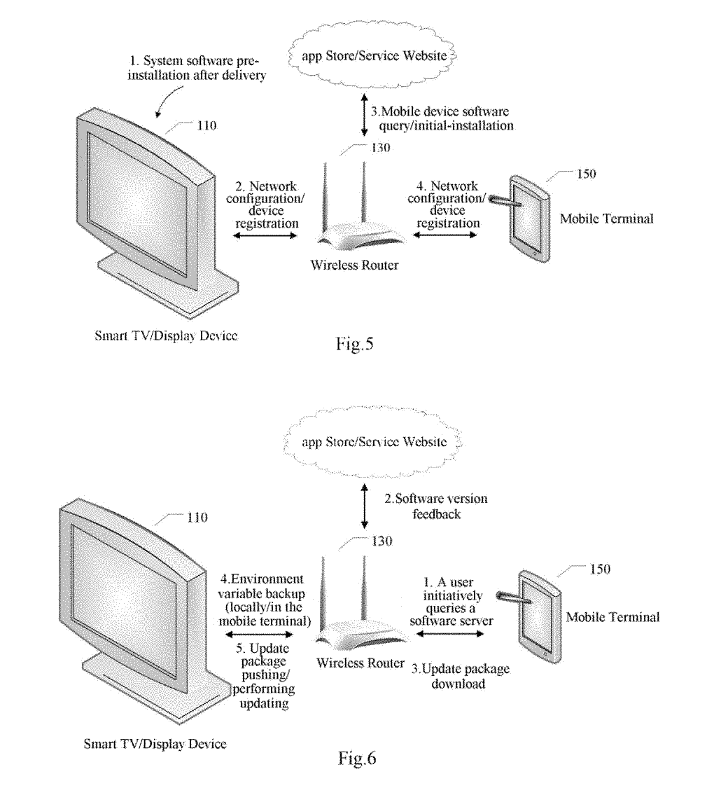

The software update unit 260 can be configured to receive a system software update package from a network server and perform the update by using the system software update package, thereby updating the platform-independent GUI presentation unit in the mobile terminal. In an embodiment, the server comprises a cloud server, thereby enhancing the practicability and extendibility of the system. After receiving the system software update package from the network server, the software package pushing unit 270 can be configured to push the part of the system software update package, which is related to the electric appliance, received by the user terminal 200 to the electric appliance. Thus, the electric appliance can update the system software in the electric appliance according to the part of the received update package, thereby realizing the upgrade and update of the system software in the entire system. The software upgrade and update process will be further described with reference to FIG. 6. In this way, the frequently updated GUI presentation unit can be transferred to the more easily updated mobile terminal, which can simplify the maintenance of the system software of the electric appliance and increase the flexibility of system software maintenance.

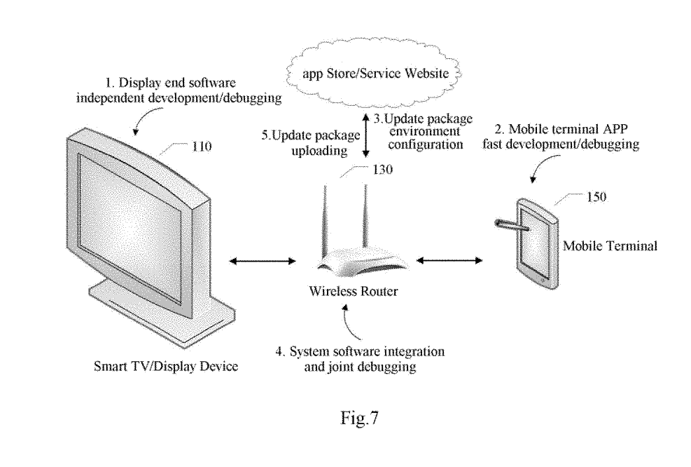

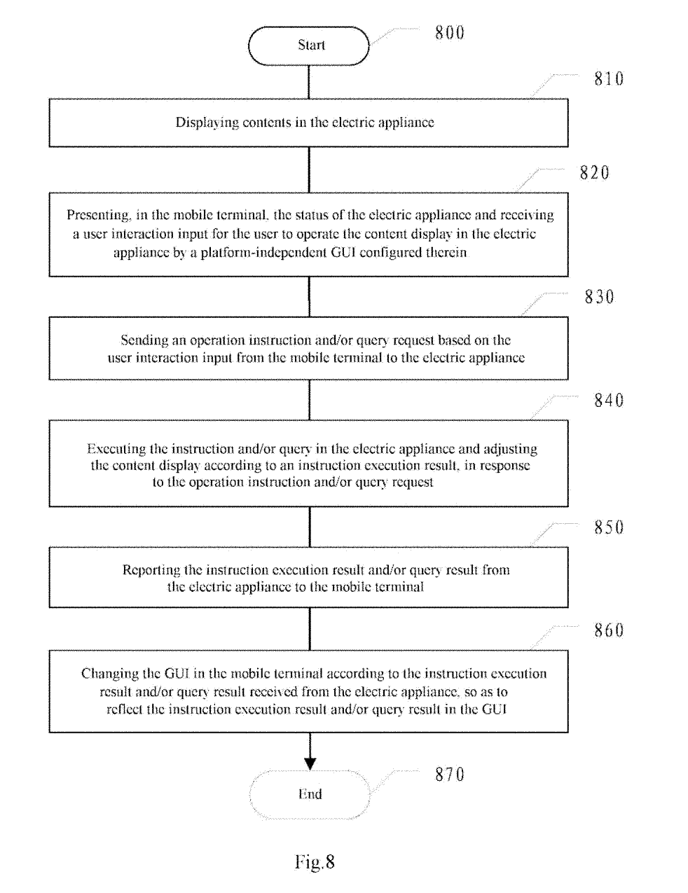

The uploading unit 280 can be configured to transmit to a network server the system software update package for the electric appliance developed in the mobile terminal or another computing device, wherein the uploaded system software update package can comprise a platform-independent GUI presentation unit or a part of the system software associated with the electric appliance. In an embodiment, the server comprises a cloud server, thereby enhancing the practicability and extendibility of the system. The development and uploading process of the system software update package will be further described with reference to FIG. 7. This manner can simplify the development and design of system software of an electric appliance, and improve the flexibility in system development and design.

In an embodiment, the system software update package can be used to configure the platform-independent GUI and/or the platform-dependent components.

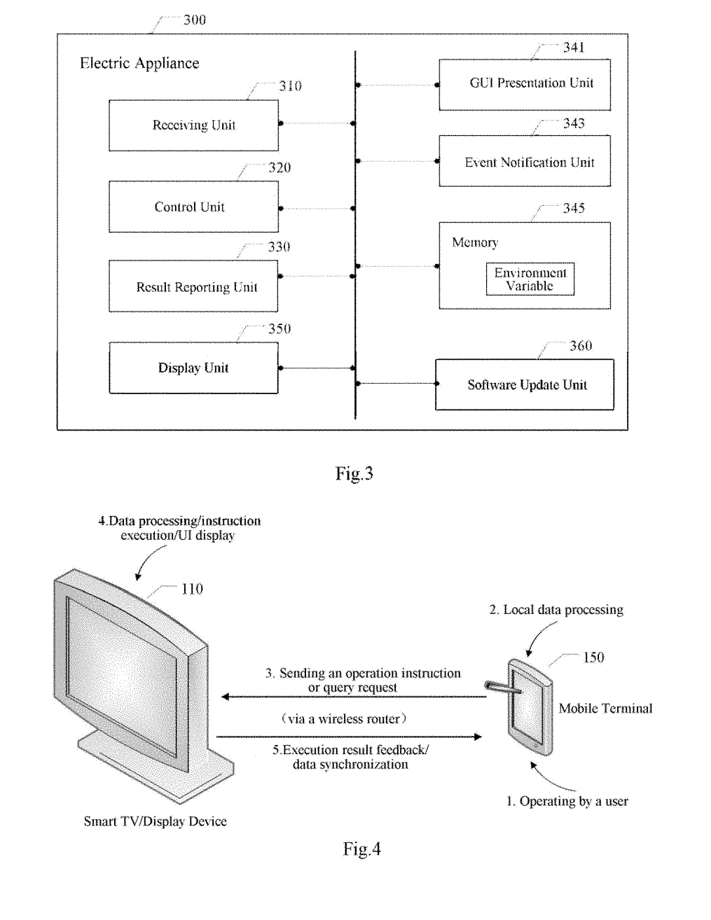

FIG. 3 is a structural block diagram of an electric appliance 300 according to an embodiment of the present disclosure. As shown in FIG. 3, the electric appliance 300 can comprise platform-dependent components, which include a receiving unit 310, a control unit 320, a result report unit 330 and a display unit 350. In some embodiments, the electric appliance 300 can further comprise a GUI presentation unit 341, an event notification unit 343, a memory 345 and/or a software update unit 360.

The display unit 350 can be configured to display the content. The display unit 350 can display the content a user desires to see, such as images, videos, web pages and documents. As described with reference to FIG. 1, the GUI used for operating the content display is presented in the mobile terminal 200 through the GUI presentation unit of the mobile terminal 200. A user can input various operation instruction and/or query request by a user interaction with the GUI in the mobile terminal 200. The receiving unit 310 of the electric appliance 300 can be configured to receive the operation instruction and/or query request from the mobile terminal. The control unit 320 can be configured to execute the instruction and/or query in response to the operation instruction and/or query request received from the mobile terminal. The display unit 350 can also be configured to adjust the content display according to the instruction execution result. For instance, when a user views images, web pages and documents, the display unit 350 can also be configured to display the next image, the next web page and the next document in response to the “next” instruction inputted by the user. When a video is being played, the display unit 350 can be configured to play the video in a fast forward mode in response to the fast forward instruction inputted by the user. The result report unit 330 can be configured to report the instruction execution result and/or query result to the mobile terminal so that the mobile terminal can reflect the instruction execution result and/or query result in the GUI therein.

In an embodiment, the electric appliance comprises a smart TV. In an embodiment, the smart TV comprises a super large screen display device configured to display the content to users. While the super large screen display device displays the content, the display is operated and controlled by the GUI in the mobile terminal. In other words, the audiences only view the content displayed through the super large screen, and the display through the super large screen is operated and controlled by a commentator or a background operator through the mobile terminal. Thus, the operation of the super large screen will not interfere the user's viewing of the displayed content.

The GUI presentation unit 341 can be configured to present the entire user interface of the smart TV itself, as an option available for the user. The user interface is made by the designer or updated later by the user, and is displayed under the independent operational mode of the smart TV itself. When receiving the instruction for displaying its own operation GUI, the smart TV is switched to an independent operation mode. The GUI presentation unit 341 displays the smart TV's own operation GUI that is independent from the GUI in the mobile terminal 200, so the smart TV does not need the mobile terminal 200 to conduct the operation and control. This manner provides users with more options and achieves forward compatibility. In an embodiment, the operation GUI comprises a user-customized GUI, for example, it can comprise a user-customized GUI pushed by the mobile terminal. This manner satisfies the increasingly personalized needs of users and provides a better user experience.

In an embodiment, on the basis of the event occurring in the mobile terminal 200 received from the mobile terminal 200, the event notification unit 343 is configured to notify the event to the user. For instance, the event comprises incall reminder, text message reminder and calendar reminder and the like. Thus, when watching the smart TV/display device, a user can know the event occurring in the mobile terminal, such as incall reminder, text message reminder and calendar reminder, without checking the mobile terminal.

The software update unit 360 can be configured to receive the pushed system software update package from the mobile terminal 200, and the system software update package comprises the part related to the electric appliance. The software update unit 360 can also be configured to update the system software in the electric appliance according to the received part of the update package. Alternatively, the software update unit 360 can also be configured to receive the system software update package from the network server to update the system software in the electric appliance. In an embodiment, the server comprises a cloud server, thereby improving the usability and expandability of the system. This process will be described more specifically with reference to FIG. 6. Since the system software required to be updated in the electric appliance is mostly related to the platform, the updating is not frequently made, which can simplify the maintenance of the system software of the electric appliance and increase the flexibility of system software maintenance.

As shown in FIG. 3, the electric appliance 300 can further comprise a memory 345 configured to store an environment variable. The environment variable can comprise various environment data including user usage data. Storage of the data can enable the system to automatically return to the previous use environment when the user uses the system again. In an embodiment, the memory 345 can be configured to back up the environment variable before updating the system software in the mobile terminal and the electric appliance. Even though the system software is updated and upgraded, the system can still automatically return to the previous use environment with the backup.

FIG. 4 is a system operation flowchart schematic view according to an embodiment of the present disclosure. As shown, the GUI for operating the smart TV/display device is displayed in the mobile terminal, and the GUI can present the state of the electric appliance and receive a user interaction input for operating the electric appliance. As the beginning of the flowchart, in step 1, the user operates the GUI to input an operation instruction/query request into a mobile terminal. In step 2, the mobile terminal conducts a local data processing and generates the operation instruction/query request. In step 3, the mobile terminal sends the generated operation instruction/query request to a smart TV/display device. The step of sending can be implemented by transferring via a wireless router or implemented by directly sending from the mobile terminal to the smart TV/display device. After receiving the operation instruction/query request, the smart TV/display device performs the instruction/query in step 4, conducts local data processing, updates and displays the user interface in some circumstances and finally generates an instruction execution result/query result. In step 5, the smart TV/display device sends the instruction execution result/query result to the mobile terminal. Similarly, the step of sending can be implemented by transferring via a wireless router or implemented by directly sending from the smart TV/display device to the mobile terminal.

FIG. 5 is a system initial installation flowchart schematic view according to an embodiment of the present disclosure. In order to enable the operation and control of the smart TV/display device by the mobile terminal immediately after delivery of the smart TV/display device, software needs to be pre-installed in the smart TV/display device before delivery. Meanwhile, before use, the mobile terminal and the smart TV/display device also need to be initially installed and configured. As shown in FIG. 5, in step 1, before delivery of the smart TV/display device, system software is pre-installed in the smart TV/display device. In step 2, network settings are configured for the smart TV/display device and the smart TV/display device is registered in the network. In the drawings, the smart TV/display device is registered in a wireless router. Those skilled in the art, however, know that in a scene where the smart TV/display device is in direct communication with the mobile terminal, the smart TV/display device and the mobile terminal can be respectively configured with their own network settings and mutually registered in the same network. In step 3, the mobile terminal needs to inquire a corresponding software application for operating the smart TV/display device, and downloads the software application from the network (such as an app store, a service network and a cloud server) and installs the software application in the mobile terminal. In the drawings, the mobile terminal inquires and downloads software applications through a wireless router. Those skilled in the art, however, know that the mobile terminal can download the software application directly from the network. After the software application is installed, the mobile terminal is configured with the network settings thereof in step 4 and is registered in the network. In the drawings, the mobile terminal is registered in a wireless router. Those skilled in the art, however, know that in a scene where the mobile terminal is in direct communication with the smart TV/display device, the mobile terminal and the smart TV/display device can be respectively configured with their own network settings and mutually registered in the same network. After the mobile terminal and the smart TV/display device are successfully configured with network settings and registered in the network respectively, the smart TV/display device can be operated by the mobile terminal. In an embodiment, after each use, the mobile terminal and the smart TV/display device can store an environment variable in their memories. The environment variable can comprise various environment data including user usage data. Storage of the data can enable the system to automatically return to the previous use environment when a user uses the system again.

FIG. 6 is a system software update flowchart schematic view according to an embodiment of the present disclosure. In step 1, a user of the mobile terminal can initiatively query a network server like a software server (such as an app store, a service network and a cloud server) so as to acquire whether there exists system software to be updated. There are also other manners to notify there is system software to be updated. For instance, the network server can directly send a message to a user, informing that there exists system software to be updated, or a system software provider adopts other manners (such as, place advertisements) to declare new system software. In case of a user's initiative request for query, the network server will feedback the latest version of system software. Having received the feedbacked software version, the mobile terminal compares it with the software version currently used in the mobile terminal to determine whether the software needs to be updated. If the software needs to be updated, the mobile terminal downloads a software update package in step 3. Then, in step 4, the mobile terminal and the smart TV/display device back up the environment variables in their respective memories. The environment variables can comprise various environment data including user usage data. If the environment variables are backuped prior to the system software update, even though the system software is updated and upgraded, the system can still automatically return to its previous use environment. In step 5, the mobile terminal pushes the part of the software update package that is related to the smart TV/display device into the smart TV/display device, and then software update is conducted in the smart TV/display device and the mobile terminal respectively. Alternatively, the smart TV/display device can also directly download a software update package from a network server. Although, in the drawings, all communications are made via a wireless router, those skilled in the art know that direct communication between the mobile terminal and the smart TV/display device is feasible, and direct communication between the mobile terminal and smart TV/display device with the network server is also feasible.

FIG. 7 is a system software R&D phase flowchart schematic view according to an embodiment of the present disclosure. In step 1, software at a display end (i.e., software installed and run in the smart TV/display device) is developed independently and is debugged in the smart TV/display device. Meanwhile, in step 2, an application at a mobile end (i.e., a software application installed and run in the mobile terminal) is quickly developed and designed, and debugged in the mobile terminal. Then, in step 3, an environment corresponding to the update package is configured to integrate and jointly debug the system software in step 4, that is to say, jointly debug the software update package in the system comprising the smart TV/display device and the mobile terminal. After a successful debugging, in step 5, the software update package is uploaded to a network server like a software server (such as an app store, a service website and a cloud server) so as to be available to other users for downloading and installation. Although, in the drawings, all communications are made via a wireless router, those skilled in the art know that direct communication between the mobile terminal and the smart TV/display device is feasible, and direct communication between the mobile terminal and smart TV/display device with the network server is also feasible.

FIG. 8 is a flowchart of a method for operating an electric appliance according to an embodiment of the present disclosure. The method starts from step 800, and moves on to step 810 to display the content in the electric appliance 300. In an embodiment, the electric appliance 300 can display the content by a display unit 350. For instance, the display unit 350 can display, in step 810, the content a user desires to see, including, but not limited to, images, videos, web pages and documents.

In step 820, in the mobile terminal, the platform-independent GUI configured in the mobile terminal is used to present the status of the electric appliance and receive a user interaction input for the user to operate the content display in the electric appliance. As described with reference to FIG. 1, the GUI that is related to operation of the content display can be presented in the mobile terminal 200 by the GUI presentation unit 210 of the mobile terminal 200. The user can input various operation instruction and/or query request by user interaction with the GUI in the mobile terminal 200. In an embodiment, the electric appliance comprises a smart TV.

In step 830, the operation instruction and/or query request based on the user interaction input is sent from the mobile terminal 200 to the electric appliance 300. In an embodiment, the mobile terminal 200 sends the operation instruction and/or query request by the sending unit 220.

In step 840, in response to the operation instruction and/or query request, the instruction and/or query is performed in the electric appliance and the content display is adjusted according to the instruction execution result. In an embodiment, the electric appliance 300 receives the operation instruction and/or query request by the receiving unit 310. Then, the electric appliance 300 can perform the instruction and/or query by the control unit 320. The electric appliance 300 can also adjust the content display by the display unit 350. For instance, when a user views images, web pages and documents, the display unit 350 can be configured to display the next image, the next web page and the next document in response to the next instruction inputted by the user. When a video is being played, the display unit 350 can be configured to play the video in a fast forward mode in response to the fast forward instruction inputted by the user.

In step 850, the electric appliance 300 reports the instruction execution result and/or query result from the electric appliance to the mobile terminal. In an embodiment, the electric appliance 300 reports the instruction execution result and/or query result by the result report unit 330.

In step 860, the GUI is changed in the mobile terminal 200 according to the instruction execution result and/or query result received from the electric appliance 300, so as to reflect the instruction execution result and/or query result in the GUI. In an embodiment, the mobile terminal 200 changes and adjusts the GUI by the GUI presentation unit 341.

In the end, the method finishes in step 870.

In an embodiment, the electric appliance comprises a super large screen display device configured to display the content to users. While the super large screen display device displays the content, the display is operated and controlled by the GUI in the mobile terminal.

In an embodiment, the method can further comprise the steps of pushing a user-customized GUI from the mobile terminal to the smart TV, and presenting the pushed user-customized GUI in the smart TV. In an embodiment, the mobile terminal 200 pushes the user-customized GUI by the GUI pushing unit 245. The electric appliance 300 can comprise its own GUI presentation unit 341 so as to present the user-customized GUI in response to a user's request for presentation of the user-customized GUI. Alternatively, the user-customized GUI can be stored in the memory 345 of the electric appliance 300, or can be received from another external source. This manner satisfies the increasingly personalized needs of users and provides a better user experience.

In an embodiment, the method further comprises the step of pushing the event occurring in the mobile terminal to the smart TV. In an embodiment, the mobile terminal pushes the event occurring in the mobile terminal by the event pushing unit. The electric appliance can comprise an event notification unit so as to notify the event occurring in the mobile terminal in response to the event pushed by the mobile terminal. Thus, when watching the smart TV/display device, a user can know the event occurring in the mobile terminal, such as incall reminder, text message reminder and calendar reminder, without checking the mobile terminal.

In an embodiment, the method is used to operate a plurality of electric appliances and the plurality of electric appliances are controlled by the mobile terminal in a centralized manner. This mode allows the centralized control mode of smart home, wherein the mobile terminal serving as a centralized control board controls the plurality of electric appliances. The centralized control mode of smart home provides a more convenient and comfortable experience for users.

In an embodiment, the method can also comprise the steps of: receiving a system software update package in the mobile terminal from a network server; and performing an update so as to use the system software update package to update a platform-independent GUI presentation unit in the mobile terminal. In an embodiment, the mobile terminal receives a system software update package and performs system software updating and upgrading by a software update unit. In this way, the frequently updated GUI presentation unit can be transferred to the more easily updated mobile terminal, which can simplify the maintenance of the system software of the electric appliance and increase the flexibility of system software maintenance. In an embodiment, the method can also comprise the steps of: pushing the part of the received update package that is related to the electric appliance from the mobile terminal to the electric appliance; and performing the update in the electric appliance according to the pushed part in response to the received pushed part so as to update system software in the electric appliance. In an embodiment, the mobile terminal pushes the partial system software update package by a software package pushing unit. The electric appliance can comprise a software update unit for receiving the partial system software update package and perform the system software upgrading and updating in the electric appliance. Since the system software required to be updated in the electric appliance is mostly related to the platform, the updating is not frequently made, which can simplify the maintenance of the system software of the electric appliance and increase the flexibility of system software maintenance. Alternatively, the software update unit of the electric appliance can also receive the system software update package from a network server.

In an embodiment, the method can also comprise the step of backing up the environment variable in the electric appliance before updating the system software. The environment variable can comprise various environment data including user usage data. Storage of the data can enable the system to automatically return to the previous use environment when a user uses the system again. Even though the system software is updated and upgraded, the system can still automatically return to the previous use environment with the backup.

In an embodiment, the method further comprises the step of transmitting a system software update package for the electric appliance developed in the mobile terminal or another computing device from the mobile terminal to a network server. In an embodiment, the mobile terminal transmits the system software update package by an uploading unit 280. This manner can simplify the development and design of system software of an electric appliance, and improve the flexibility in system software development and design.

In an embodiment, the system software update package is used to configure the platform-independent GUI and/or the platform-dependent components.

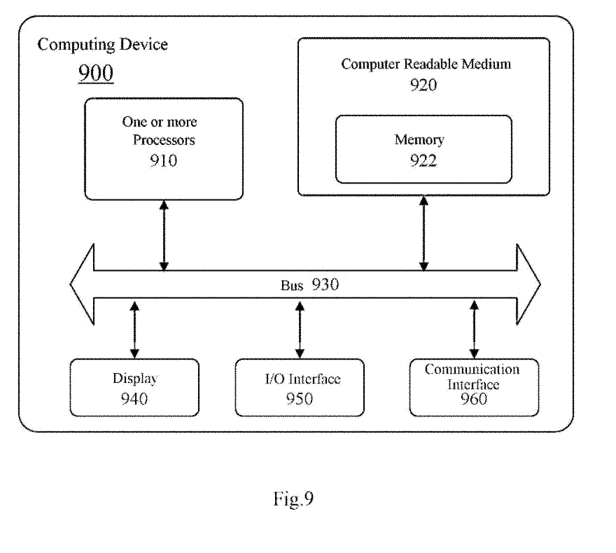

FIG. 9 illustrates an exemplary computing device 900 that can be used to implement one or more embodiments of the disclosure. In particular, the electric appliance or mobile terminal according to some embodiments of the present disclosure can be implemented in the exemplary computing device 900. As shown, the exemplary computing device 900 comprises one or more processors 901 or processing units, and one or more computer readable media 920 that can comprise one or more memories 922, one or more displays 940 for displaying contents to a user, one or more input/output (I/O) interfaces 950 for use in an input/output (I/O) device, one or more communication interfaces 960 for communication with other computing devices or communication devices, and a bus 930 which allows mutual communication between different components and devices.

The computer readable medium 920, the display 940 and/or the one or more I/O devices can be included as a part of the computing device 900, or alternatively can be coupled to the computing device 900. The bus 930 represents one or more types of bus structures, comprising a storage bus or a storage controller, a peripheral bus, an accelerated graphics port, and a processor or local bus of any structure employing various bus architectures. The bus 930 can comprise a wired and/or wireless bus.

There is no limitation imposed on the one or more processors 910 in terms of the material thereof or the processing mechanism used therein. For instance, a processor can consist of one or more semi-conductors and/or transistors (such as, an electronic integrated circuit (IC)). Under this background, a processor executable instruction can be an electrically executable instruction. The memory 922 represents memory/storage capacity associated with one or more computer readable media. The memory 922 can comprise a volatile medium (such as a random access memory (RAM)) and/or a non-volatile medium (such as a read-only memory (ROM), a flash memory, a compact disk and a disk). The memory 922 can comprise a fixed medium (such as RAM, ROM and a fixed hard disk drive) and a removable medium (such as a flash memory drive, a mobile hard disk drive and a compact disk).

The one or more input/output interface 950 allows a user to input commands and information into the computing device 900, and also allows information to be presented to the user and/or to other components or devices by a different input/output device. Examples of the input device comprise a keyboard, a touch screen display, a cursor control device (such as a mouse), a microphone, a scanner, etc. Examples of the output device comprise a display device (such as a monitor or projector), a speaker, a printer, a network card, etc.

The display 940 allows the display of various data/contents and GUIs to a user. Although the display 940 is shown in the drawings, the display 940 may be absent in some embodiments. For instance, in some embodiments of the display device, it is possible to have no display 940. The display 940 shown in FIG. 9 is only to indicate that the display 940 should exist at least for various embodiments of the mobile terminal.

The communication interface 960 allows communication with other computing devices or communication devices. There is no limitation imposed on the communication technologies adopted by the communication interface 960. The communication interface 960 can comprise a wired communication interface such as a LAN communication interface and a WAN communication interface, and also a wireless communication interface such as an infrared, Wi-Fi or Bluetooth communication interface.

The technologies herein are described in a general context of software, hardwire (fixed logic circuits) or program modules. Generally speaking, the program module comprises routines, programs, objects, elements, components, data structures and the like for performing specific tasks or implementing specific abstract data types. The implementations of these modules and technologies can be stored in some form of computer readable medium or delivered via the computer readable medium. The computer readable medium can comprise various usable medium or media accessible by a computing device. As an example rather than a limitation, the computer readable medium can comprise “a computer readable storage medium” and “a communication medium”.

“A computer readable storage medium” can refer to a medium and/or device that allows continuous and/or non-instantaneous storage of information in contrast to signal transmission, carrier waves or signals themselves. The computer readable storage medium comprises volatile and non-volatile, removable and non-removable media and/or storage devices implemented by a method or technology suitable for storing information, and the information, for example, can comprise computer readable instructions, data structures, program modules, logic elements/circuits or other data. The examples of the computer readable storage media can comprise, but are not limited to, RAM, ROM, EEPROM, flash memories, CD-ROM, digital multi-functional disks (DVD) or other optical storage device, hard disks, cassettes, magnetic tapes, disk storage or other magnetic storage devices, hardware elements (such as fixed logics) of integrated circuits or chips, or other storage devices, tangible media, or manufactured products adaptable for storage of desired information and accessible by a computer.

“A communication medium” can refer to signal carrying medium that can be configured to, e.g., transmit instructions to hardware of a computing device via a network. The communication medium typically comprises computer readable instructions, data structures, program modules or other data in modulation data signals, such as carrier waves, data signals or other transmitting mechanisms. The communication medium also comprises any information delivery medium. The term “modulation data signals” refers to signals that have one or more characteristics set or changed to encode information therein. As an example rather than a limitation, the communication medium comprises a wired medium such as a wired network or a direct wired connection, and a wireless medium such as ultrasonic, RF, infrared and other wireless medium.

Correspondingly, specific modules, functions, components and technologies described herein can be implemented in software, hardware, firmware and/or combination thereof. The computing device 900 can be configured to execute specific instructions and/or functions corresponding to software and/or hardware module(s) implemented on the computer readable medium. The instructions and/or functions can be executed/operated by a manufactured product (such as one or more computing devices 900 and/or processors 910) so as to implement the technologies used herein. Such technologies comprise, but are not limited to, the exemplary process described herein. Hence, the computer readable medium can be configured to store or provide instructions for implementing the above-mentioned different technologies when accessed by one or more devices described herein.

Although some embodiments of the present disclosure are specifically described with reference the drawings, those skilled in the art shall understand that the above specific illustration is merely for explaining the disclosure, and the invention is not at all limited to the above specific embodiments. Based on the specific depiction and teachings of those embodiments herein, those skilled in the art can make various modifications, additions, replacements and variations to those embodiments without departing from the protection scope of the invention. That is, the modifications, additions, replacements and variations shall be covered by the protection scope of the appended claims. The protection scope of the present invention depends the scope of the claims. Specific features and acts described herein are disclosed as examples for implementing the claims.

The terms “comprise”, “include” or other similar terms are intended for a non-exclusive coverage, such that a process, method, article or device comprising a series of elements comprises not only those elements but also other elements that are not explicitly listed, or intrinsic elements of the process, method, article or device. Unless otherwise explicitly indicated, “a” or “an” before an element does not exclude the possibility that the process, method, article or device comprising the element still has additional similar elements.

1. A system for operating an electric appliance by a mobile terminal, comprising: the electric appliance and the mobile terminal, wherein the mobile terminal comprises
a platform-independent Graphics User Interface GUI presentation unit configured to present a GUI comprising at least one GUI element, the at least one GUI element being configured to display the status of the electric appliance or receive a user interaction input for the user to operate the electric appliance;
a sending unit configured to send, to the electric appliance, an operation instruction or query request based on the user interaction input; and
a result receiving unit configured to receive an instruction execution result or query result from the electric appliance;
wherein the electric appliance comprises platform-dependent components, which include:
a receiving unit configured to receive the operation instruction or query request from the mobile terminal;
a control unit configured to execute the instruction or query in response to the operation instruction or query request received from the mobile terminal;
a display unit configured to display contents and adjust the content display according to the instruction execution result; and
a result report unit configured to report the instruction execution result or query result to the mobile terminal,
wherein the GUI presentation unit changes at least one GUI element presented according to the instruction execution result or query result received from the electric appliance, so as to reflect the instruction execution result or query result in the presented GUI.

2. The system according to claim 1, wherein the electric appliance comprises a smart TV.

3. The system according to claim 2, wherein the smart TV comprises a GUI presentation unit, the at least one GUI element in the mobile terminal comprises an option available for user selection; and when the user selects the option, the GUI presentation unit of the smart TV displays a GUI independent from the at least one GUI element.

4. The system according to claim 2, wherein the mobile terminal comprises a GUI pushing unit configured to push a user-customized GUI to the smart TV,
the smart TV comprises a GUI presentation unit configured to present the user-customized GUI.

5. The system according to claim 1, wherein the electric appliance comprises a plurality of electric appliances and the plurality of electric appliances are controlled by the mobile terminal in a centralized manner.

6. The system according to claim 1, wherein the mobile terminal comprises
a user identification unit configured to identify a user logged in to the mobile terminal;
a memory configured to store a plurality of user profiles associated with a plurality of users, each user profile defining the GUI used for a corresponding user,
wherein the GUI presentation unit is configured to present a corresponding GUI according to the user profile corresponding to an identified user.

7. The system according to claim 1, wherein the mobile terminal comprises a software update unit configured to receive a system software update package from a network server and update the platform-independent GUI presentation unit in the mobile terminal.

8. The system according to claim 7, wherein the mobile terminal also comprises a software package pushing unit configured to push the part of the received update package that is related to the electric appliance to the electric appliance, and
the electric appliance further comprises a software update unit configured to update system software in the electric appliance according to the part of the received update package.

9. The system according to claim 1, wherein the electric appliance comprises a memory configured to store an environment variable.

10. The system according to claim 9, wherein the memory is configured to back up the environment variable before updating the system software in the mobile terminal and the electric appliance.

11. The system according to claim 1, wherein the mobile terminal further comprises an uploading unit configured to transmit to a network server the system software update package for the electric appliance developed in the mobile terminal or another computing device.

12. The system according to claim 11, wherein the system software update package is used to configure the platform-independent GUI or the platform-dependent components.

13. A mobile terminal for use in a system according to claim 1.

14. A method for operating an electric appliance by a mobile terminal, comprising the steps of:
displaying contents in the electric appliance;
presenting, in the mobile terminal, the status of the electric appliance and receiving a user interaction input for the user to operate the content display in the electric appliance by a platform-independent GUI configured therein;
sending an operation instruction or query request based on the user interaction input from the mobile terminal to the electric appliance;
executing the instruction or query in the electric appliance and adjusting the content display according to an instruction execution result, in response to the operation instruction or query request;
reporting the instruction execution result or query result from the electric appliance to the mobile terminal; and
changing the GUI in the mobile terminal according to the instruction execution result or query result received from the electric appliance, so as to reflect the instruction execution result and/or query result in the GUI.

15. The method according to claim 14, wherein the electric appliance comprises a smart TV.

16. The method according to claim 15, further comprising the steps of:
pushing a user-customized GUI from the mobile terminal to the smart TV, and
presenting the pushed user-customized GUI in the smart TV.

17. The method according to claim 14, further comprising the steps of:
receiving a system software update package in the mobile terminal from a network server; and
performing an update so as to use the system software update package to update the platform-independent GUI presentation unit in the mobile terminal.

18. The method according to claim 17, further comprising the steps of:
pushing the part of the received update package that is related to the electric appliance from the mobile terminal to the electric appliance; and
performing the update in the electric appliance according to the pushed part in response to the received pushed part, so as to update system software in the electric appliance.

19. The method according to claim 18, further comprising the step of backing up an environment variable in the electric appliance before updating the system software.

20-21. (canceled)

22. A computer readable storage medium that stores a computer readable instruction, when executed by a computing device, enabling the computing device to perform any method according to claim 14.
